(19) United States
(12) Patent Application Publication
(10) Pub. No.: US 2012/0188126 A1
(43) Pub. Date: Jul. 26, 2012

(54) Synthetic Aperture Antenna Device for Transmitting Signals of a Satellite Navigation System Comprising a Carrier and Means for Determining its Trajectory

(75) Inventor: Marc Revol, Upic (FR)

(73) Assignee: THALES, Neuilly-sur-Seine (FR)

(21) Appl. No.: 13/185,649

(22) Filed: Jul. 19, 2011

(30) Foreign Application Priority Data
Jul. 19, 2010 (FR) FR1003025

(51) Int. Cl. G01S 19/29

(52) U.S. Cl. 342/357.68

(57) ABSTRACT

A synthetic aperture antenna device for transmitting signals of a system includes a carrier and means for determining its trajectory, and, for each signal respectively associated with a spatial direction, processing means suitable for generating a stationary phase signal over a time window corresponding to the distance traveled by the device throughout the period of coherent integration, before modulation of the received signal, the processing means comprising correction means suitable for correcting the carrier phase of the signal.

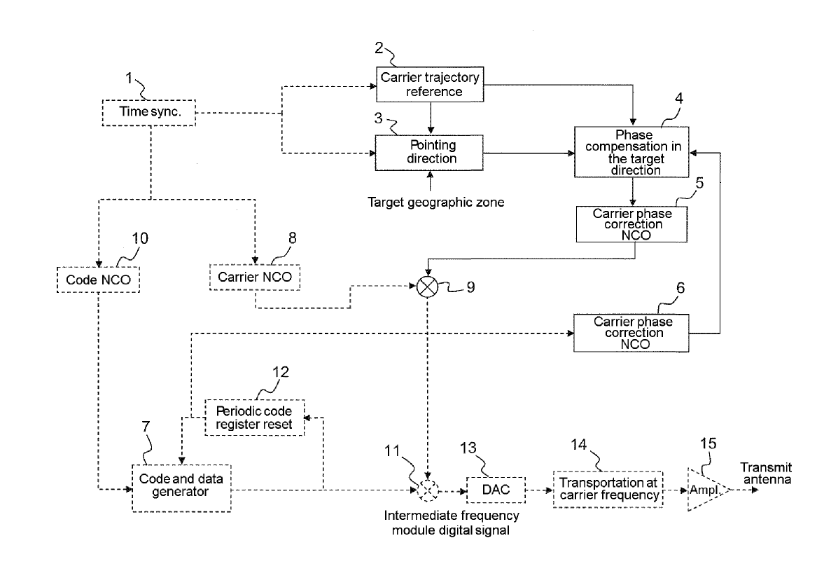

### CROSS-REFERENCE TO RELATED APPLICATION

This application claims priority to foreign French patent application No. FR 1003025, filed on Jul. 19, 2010, the disclosure of which is incorporated by reference in its entirety.

### FIELD OF THE INVENTION

The invention relates to a signal transmitter of a satellite navigation system designed to improve the robustness of transmission of the signals in the direction of dedicated reception zones.

### BACKGROUND

Cooperative transceiver devices of the location or telecommunication type involve a coupling of the receiver to the carrier phase of the received signal.

An example thereof is given by the satellite radio navigation systems GNSS which use a constellation of satellites revolving around the earth in very precisely determined orbits. Thus, it is possible to ascertain at any moment the position of any satellite. The orbits of the satellites are chosen so that, at any time, 6 to 12 satellites are visible at any point on earth. Each satellite transmits several radio electric signals of determined modulation and frequency type. On the ground or on a land, sea or air vehicle, a receiver receives the signals transmitted by visible satellites.

A location receiver measures the propagation time required for a time mark transmitted by a satellite to reach it. The time marks are encoded on carrier waves using the phase modulation technique. This time multiplied by the speed of light in the environment traversed gives a distance measurement called pseudo distance. On the basis of the measurements of the pseudo distances separating it from each visible satellite and of the knowledge of the position of the satellites, the receiver deduces its precise position in latitude, longitude and in altitude in a terrestrial coordinate by a digital resolution similar to triangulation. Based on the phase measurements (Doppler) of the carriers, and on the precise knowledge of the apparent speed of the satellites, the receiver computes the speed precisely. It can also deduce therefrom the precise date and time in the temporal coordinate of the satellite navigation system.

The reception of the satellite signals and the precision of the measurements remains extremely sensitive despite the widening of the spread codes and the increase in the transmission powers, to the presence of scrambling and interference sources, and to the existence of reflected paths.

One improvement method involves the use of directive transmit antennas making it possible to improve the transmit gain and to promote reception in reception zones dedicated to the applications. However, these solutions impose restrictive antenna sizes on the satellite, and substantially increase the hardware complexity for the radiofrequency RF stages of the transmitter (as many RF channels as antenna elements) and the computing load.

### SUMMARY OF THE INVENTION

The invention limits the complexity of such transmit antennas by reducing their dimension and the complexity of their processing.

According to one aspect of the invention, a synthetic aperture antenna device is proposed for transmitting signals of a satellite navigation system comprising a carrier and means for determining its trajectory, the said device comprising, for each signal respectively associated with a spatial direction, processing means suitable for generating a stationary phase signal over a time window corresponding to the distance traveled by the device throughout the period of coherent integration, before modulation of the said signal, the said processing means comprising correction means suitable for correcting the carrier phase of the said signal.

Such a device makes it possible to limit the complexity of the transmit antenna by reducing the processing load. Moreover, synthetic antenna processing makes it possible to obtain considerable gains in directivity in any target direction, without common measurement with those that can be reached by network antennas because of the bulk and the number of individual antennas that would then be necessary, thus making it possible to improve the transmit gain in the direction of the chosen zone, while masking the transmission in the other directions, and making location outside the defined zone impossible. Because of the simplicity of the proposed synthetic antenna processing, it is possible to carry out simultaneous transmission for different target directions associated with each satellite.

In one embodiment, said correction means comprise, in order to correct the carrier phase of the said signal:
first means for determining a speed vector of movement of the device;
means for orthogonal projection of the said speed vector of movement of the device in the direction of the said signal;
a first digitally-controlled oscillator receiving the said orthogonal projection as an input;
a first multiplier (9) in order to compensate for the phase of the carrier signal generated by a second carrier digitally-controlled oscillator (8) by the signal delivered by the said first digitally-controlled oscillator (5);
a second multiplier (11) in order to multiply the signal delivered by the said first multiplier (9) and the complex base components of the spread code of the signal generated by a code generator (7); and
frequency transposition means (14) and amplification means (15) for transfer to the transmit antenna of the signal delivered by the second multiplier (11) over a time interval with a duration T corresponding to a period of the spread code.

Such an embodiment makes it possible to retain the conventional architecture of a satellite navigation system transmitter. The phase compensation is carried out at low rate before correlation by the local code.

According to another aspect of the invention, also proposed is a method for the transmission, by synthetic aperture antenna, of signals of a satellite navigation system comprising a carrier and means for determining its trajectory, in which, for each signal respectively associated with a spatial direction, processing is carried out suitable for generating a stationary phase signal over a time window corresponding to the distance traveled by the device throughout the duration of coherent integration, before modulation of the said signal by the said code, the said processing comprising a correction of the carrier phase of the said signal.

According to one mode of application, said carrier phase correction of the signal comprises, in acquisition phase or in pursuit phase:
a determination of a speed vector of movement of the said antenna;
an orthogonal projection of the said speed vector of movement in the direction of transmission of the said signal;
a generation of a carrier phase correction signal, synchronized over the period of the spread code, carried out by a phase-controlled digital oscillator on the basis of the speed of movement of the antenna in the direction of transmission of the signal;
a resetting of the said correction signal at each beginning of a period of the said spread code;
a multiplication into complex base components of the said correction signal and of the signal to be transmitted, synchronized over each time interval with a duration T corresponding to a period of the spread code; and
a coherent transmission of the signal resulting from the said multiplication.

The phase correction thus carried out makes it possible to compensate for the change in phase of the signal corresponding to the movement of the carrier in the target direction, then making it equivalent to that which would be delivered in the case of a movement contained in a plane orthogonal to the target direction, thus ensuring that the signals that are transmitted in the target direction are made coherent.

### BRIEF DESCRIPTION OF THE DRAWINGS

The invention will be better understood on studying an embodiment described as a non-limiting example and illustrated by the appended drawing illustrating schematically an embodiment of the invention in coherent transmission on the carrier.

### DETAILED DESCRIPTION

In general, mention is made of “synthetic antenna” when a deficient resource, such as a lack of space, or an operating restriction, is replaced by time. This assumes a certain spatial stability of the scene: it may be a perfect coherence (SAR, SAS, seismic or echography), or simply a second-order spatial stationarity (aperture synthesis in radioastronomy).

The techniques of synthetic antennas are known in receive mode in the fields of cartography, of sounding or of echography.

Specifically, the synthetic antenna, originally applied in receive mode to radar cartography or SAR for “Synthetic Aperture Radar”, uses the specific movement of the vehicle carrying the physical antenna. It artificially manufactures or simulates a large-size antenna, the geometry of which corresponds to the space covered by the antenna when it moves.

The application to the field of satellite navigation provides new horizons because of the need to respond simultaneously to constraints of limitation of the complexity of the transmitters that are increasingly integrated, and to the need to ensure the increasing integrity and continuity of the measurements produced.

In the case of satellite navigation system signal synthesis, the transmitted signal is controlled in phase and in delay. Everything happens as if there were a transmit antenna, the geometry of which corresponded to all of the positions occupied by the transmit antenna. It is therefore possible to reconstitute the transmit diagram after the fact by totaling the signals available at the various moments of transmission, taking account of the movement of the transmitter.

Consider a movable transmitter consisting of a simple antenna and the sequence {(e(tₙ))}, (n a variant from 1 to N) of the signals available on the transmit antenna at successive moments (tₙ), at which the antenna occupies variable positions. If the signals in question are totaled, it is the equivalent of producing the signal that would effectively be transmitted on a composite antenna of N sensors on which the signals {(e(tₙ))} were applied simultaneously to all the individual transmitters of the antenna.

It is then possible to apply phase shifts {τₙ}_{n=1,N} to the previous signals, these phase shifts being able to be computed so as to compensate for the natural phase shift of the transmit signal associated with the movement (corresponding to the change in phase of the signal as a function of time considered at different positions of the transmit antenna) and so as to orient the virtual transmit antenna in the target direction (channel formation). This possibility of orienting the transmit antenna in any direction is the main value of the synthetic transmit antenna.

There remains however a difference between a synthetic antenna and a real antenna network: the electronic noise for each measurement is increased relative to what it would be if there was effectively the complete transmit antenna. In transmission, the antenna gain is in a ratio \sqrt{N} instead of N.

Moreover, in order to apply such a process, it is necessary to know the trajectory traveled by the antenna throughout the period of coherent integration, with an accuracy better than λ/8, λ being the wavelength of the carrier or of the sub-carrier.

The process can be carried out from a single individual antenna, or from a plurality (network antenna) if it is already available, and limits the increase in complexity on the hardware or the internal processing of the transmitter. Moreover, this processing provides a robust solution preventing any form of calibration ordinarily associated with the spatial processing based on individual antennas placed in a network. It takes advantage of the known movement of the carrier, i.e. of the device itself (for example originating from an orbitography in the case of a satellite, or from an inertial or odometric reference, or even from cartographic reference) and of the time coherence of the phase of the signals in order to produce a virtual antenna.

Synthetic antenna processing makes it possible to obtain considerable gains in directivity in any target transmission direction, greater than those that can be achieved by network antennas because of the bulk and the number of individual antennas that would then be necessary. Because of the simplicity of the proposed synthetic antenna process, it is possible to carry out pursuit simultaneously for various directions of transmission of the signals transmitted by each satellite.

The proposed synthetic antenna processing makes it possible to focus the signals in any transmit direction. Correction in time of the phase specifically makes it possible to carry out complete processing of compensation of the phase of the wave transmitted in any direction.

This processing makes it possible to use the conventional architecture of the known transmitters without considerable rework.

A synthetic antenna effect is reconstituted in the case of a satellite navigation system transmitter based on knowing the movement of the transmit antenna (considered to be an individual sensor) without modifying the conventional transmission processing architecture. The antenna effect is obtained by compensation of the phase of the transmitted signal.

Thus, the synthetic aperture antenna device can be oriented in any one or more directions, and controlled by external control. The amplitude and phase weighting coefficients of the synthetic aperture antenna device are applied to the complex outputs after correlation by the local code and before coherent integration, and the diagram of directivity of the synthetic device can be optimized for each target direction, so as to minimize the level of secondary lobes of the spatial directivity function (Hamming weighting, etc.) and in order to minimize the effect of interference by creation of zeroes in the source directions.

The advantages of a synthetic aperture antenna device for transmitting signals of a satellite navigation system according to the invention are as follows:

improved sensitivity of reception over all the satellite signals in view,

availability of the location service in one or more small-area geographic zones, and

masking of the location service in one or more small-area geographic zones.

The method consists in compensating for the phase of the transmit signal corresponding to the movement made by the carrier, in the direction targeted by the antenna. The transmitted signal may result from the superposition of phase-compensated signals for several directions simultaneously.

In order to explain the principle, we restrict ourselves to a single target direction. In the case of a conventional transmission of signals of a satellite navigation system, the phase of the carrier is determined by an ultra-sensitive atomic clock on board which fixes the time reference.

The principle consists in compensating for the carrier phase of the signal during the development phase of the digital signal (before analogue conversion) without changing the principle of generating the code.

Seen from a receiver that is in a target zone, by the transmit antenna, the power of the received signal will be greater (increased by the “directivity” of the transmit synthetic antenna) and the apparent phase is stable so long as the phase compensation in transmission lasts (fixed apparent position).

On the other hand, the phase of the spread code (group delay) remains associated with the movement of the satellite.

In order to maintain the coherence of phase between the code and the carrier, the phase of the carrier should be periodically adjusted to that of the code, for example by compensating for the carrier phase only on a whole number of lengths of BPSK periodic code. This means that it is necessary to synchronize the periods of coherent integration post correlation of the phase loop of the receiver on the periods of return to coherence of the transmit signal.

With this precaution being taken, the processing architecture of the transmitter remains identical to that of a standard transmitter of a satellite navigation system.

The FIGURE illustrates schematically an embodiment of the invention in coherent acquisition on carrier. The elements in dashed lines represent elements present in a conventional signal transmission device and the elements in solid lines represent the elements specific to the production of a synthetic antenna in transmission.

A time synchronization module 1 makes it possible to synchronize the modelling of the reference trajectory of the transmitter with the generation of the correction signal, computed on the satellite, by the use of an ultra-stable common clock.

The timebase generated by the synchronization module 1 allows the trajectory determination module 2 to compute the speed \vec{V}ₚ of movement of the transmitter, i.e. of the device, at the present moment.

A module 3 for determining the target direction makes it possible, based on the timebase generated by the synchronization module 1, to determine the orientation of pointing of the beam of the synthetic antenna based on the position of the transmitter and on the position of the geographic zone to be covered by the transmit beam.

Based on the speed of movement of the transmitter \vec{V}ₚ, a correction module 4 computes the phase correction of the transmitted signal corresponding to the projection of the speed of movement of the device in the direction of the transmitted signal, from the target direction \vec{d} delivered by the determination module 3.

This phase correction computed by the module 4 is applied to control a digitally controlled oscillator 5 in order to correct the phase of the transmit carrier.

A reset module 6 makes it possible to reset the phase correction in a synchronous manner with the periodic generation of code carried out by a generation module 7.

A transmit carrier digitally controlled oscillator 8, maintained by the clock of the timebase of the module 1, makes it possible to generate a signal at the specified frequency of the transmitted signal carrier. A multiplier 9 multiplies the output signals of the transmit carrier digitally controlled oscillator 8 and of the phase correction digitally controlled oscillator 5 of the transmit carrier.

A code digitally controlled oscillator 10, maintained by the clock of the timebase of the module 1, makes it possible to control the delay of the code generated by the code and data generator 7. A multiplier 11 carries out the product of the output signal of the generator 7 and of the output signal of the multiplier 9.

A reset module 12 makes it possible to periodically reset the code generator 7 and in parallel supplies a signal making it possible to synchronize the resetting of the phase correction carried out by the reset module 6.

The digital signal originating from the multiplier 11 is then conventionally converted into an analogue signal by a digital/analogue converter 13, transposed to the transmit frequency RF by a transposition module 14, and amplified by an amplifier 15 before being sent to the transmit antenna.

The present invention makes it possible to limit the complexity of an antenna for transmitting signals of a satellite navigation system, by reducing the processing load. Moreover, the synthetic antenna processing makes it possible to obtain considerable gains in directivity in any target direction without common measurement with those that can be reached by network antennas because of the bulk and of the number of individual antennas that would then be necessary, thus making it possible to improve the transmit gain in the direction of the chosen zone, while masking the transmission in the other directions, and while making location outside the defined zone impossible.

Because of the simplicity of the proposed synthetic antenna processing, it is possible to achieve the simultaneous transmission for various target directions associated with each satellite.

1. A synthetic aperture antenna device for transmitting signals of a satellite navigation system comprising:
a carrier and means for determining its trajectory, and,
for each signal respectively associated with a spatial direction, processing means suitable for generating a stationary phase signal over a time window corresponding to the distance traveled by the device throughout the period of coherent integration, before modulation of the said signal,
said processing means comprising correction means suitable for correcting the carrier phase of the said signal.

2. The device according to claim 1, in which said correction means further comprise, in order to correct the carrier phase of the said signal in acquisition phase or in pursuit phase:
first means for determining a speed vector of movement of the device;
means for orthogonal projection of the said speed vector of movement of the device in the direction of said signal;
a first digitally-controlled oscillator receiving said orthogonal projection as an input;
a first multiplier in order to compensate for the phase of the carrier signal generated by a second carrier digitally-controlled oscillator by the signal delivered by the said first digitally-controlled oscillator;
a second multiplier in order to multiply the signal delivered by said first multiplier and the complex base components of the spread code of the signal generated by a code generator; and
frequency transposition means and amplification means for transfer to the transmit antenna of the signal delivered by the second multiplier over a time interval with a duration T corresponding to a period of the spread code.

3. A method for the transmission, by synthetic aperture antenna, of signals of a satellite navigation system comprising a carrier and means for determining its trajectory, in which, for each signal respectively associated with a spatial direction, processing is carried out suitable for generating a stationary phase signal over a time window corresponding to the distance traveled by the device throughout the duration of coherent integration, before modulation of the said signal by the said code, the said processing comprising a correction of the carrier phase of the said signal.

4. The method according to claim 3, in which said carrier phase correction of the said signal comprises, in acquisition phase or in pursuit phase:
a determination of a speed vector of movement of the said antenna;
an orthogonal projection of the said speed vector of movement in the direction of transmission of the said signal;
a generation of a carrier phase correction signal, synchronized over the period of the spread code, carried out by a phase-controlled digital oscillator on the basis of the speed of movement of the antenna in the direction of transmission of the signal;
a resetting of the said correction signal at each beginning of a period of the said spread code;
a multiplication into complex base components of said correction signal and of the signal to be transmitted, synchronized over each time interval with a duration T corresponding to a period of the spread code; and
a coherent transmission of the signal resulting from the said multiplication.
